(19) United States
(12) Patent Application Publication
(10) Pub. No.: US 2026/0129445 A1
(43) Pub. Date: May 7, 2026

(54) SYSTEMS AND METHODS FOR USE IN SYNCHRONIZING KEYS FOR ENHANCED AUTHENTICATION AVAILABILITY

(71) Applicant: MASTERCARD INTERNATIONAL INCORPORATED, PURCHASE, NY (US)

(72) Inventors: Ameya Vinayak Sohoni, Pune (IN); Kaushal Shetty, O'Fallon, MO (US); Mayank Joshi, Pune (IN)

(21) Appl. No.: 18/936,916

(22) Filed: Nov. 4, 2024

(51) Int. Cl. H04W 12/062; H04W 12/04; H04W 12/30

(52) U.S. Cl. CPC H04W 12/062; H04W 12/04; H04W 12/30

(57) ABSTRACT

Systems and methods are provided for use in consent-based synchronization of keys for enhanced authentication availability. One example computer-implemented method includes receiving, by a first fast identity online (FIDO) server, from a second FIDO server, a signed consent token, which is signed by a first private key specific to a mobile device of a user; retrieving a user profile for a user; verifying the signed consent token based on a first public key included in the user profile; based on the successful verification of the consent token, generating a response token, which includes the first public key; signing the response token with a second private key unique to the first FIDO server; and transmitting the signed response token to the second FIDO server.

### FIELD

The present disclosure generally relates to systems and methods for synchronizing keys for enhanced authentication availability, and in particular, to extending public keys to additional servers to extend authentication for related services, thereby enhancing availability of the authentication.

### BACKGROUND

This section provides background information related to the present disclosure which is not necessarily prior art.

It is known for entities to rely on authentication to ensure that an entity is interacting with a person rightfully associated with identifying attributes. In connection therewith, fast identity online authentication, or FIDO authentication, is a set of open, standardized authentication protocols for use in place of passwords for authentication. The FIDO authentication may be used for a variety of entities. In use, the entity offers FIDO authentication, whereby as part of a registration process, a user's device creates a key pair that is unique to the device, and also an online service and/or a user account. The user's device retains the private key from the pair, and transmits the public key from the pair to a FIDO server of the entity. The FIDO server stores the public key for the user (or user's device). The key pair is later used, through the user's device, alone or in combination with a biometric, username, password, etc., for the user to authenticate with the entity.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in synchronizing keys for enhanced authentication availability;

FIG. 2 is a block diagram of an example computing device that may be used in the system of FIG. 1; and

FIG. 3 includes a flow diagram of an example method, which may be implemented in connection with the system of FIG. 1, for use in effecting consent-based synchronizing keys for enhanced authentication availability for network services.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with fast identity online (FIDO) authentication, a user registers from a user device, whereby a key pair is generated and the public key of the pair is shared with a FIDO server, in connection with a service. Upon accessing the service, as necessary for authentication, the FIDO server participates to verify data with the public key. For various reasons, the FIDO server may be down, or otherwise unavailable, whereby access to the service is eliminated, or limited to additional authentication. In either instance, the user experiences associated friction in accessing the service, based on the unavailable FIDO server.

Uniquely, the systems and methods herein provide for synchronizing keys for enhanced authentication availability (e.g., across FIDO servers, etc.). In particular, multiple FIDO servers are defined for a service. The user initially registers with one of the FIDO servers, and then consents (e.g., for a service, entity, interval, etc.) to share the public key generated from the enrollment with the one of the FIDO servers, with one or more additional ones of the FIDO servers. The initial one of the FIDO servers, through the operations described herein, then shares the public key with/to the one or more additional ones of the FIDO servers, whereby any one of the FIDO servers is available for authentication of the user in connection with the service.

In this manner, one of the FIDO servers (e.g., the FIDO server with which the user registered, etc.) may be unavailable without impacting availability of the service.

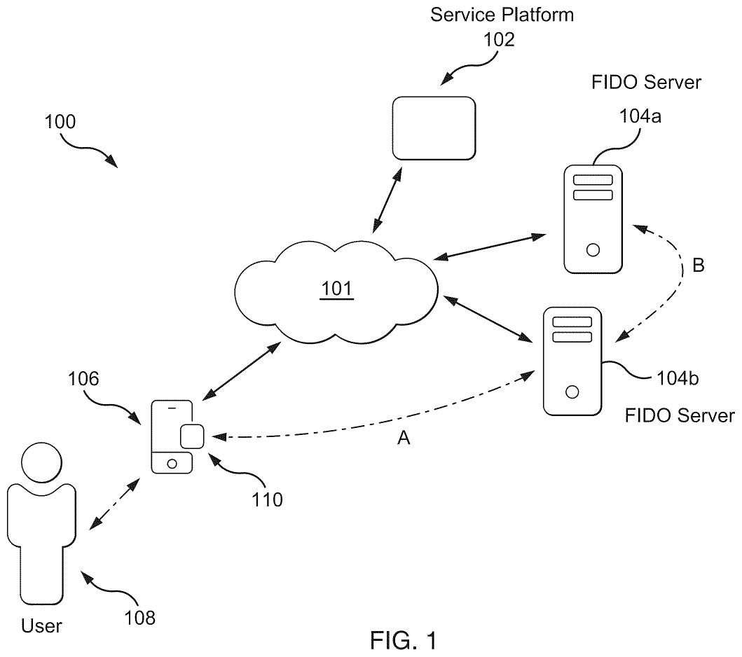

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, service types, authentication requirements, privacy regulations and/or requirements, etc.

The system 100 includes a service platform 102 (or service provider, etc.), multiple FIDO servers 104a-b, and a mobile device 106 associated with a user 108, each of which is coupled to (and is in communication with) one or more networks, represented by the cloud 101 in FIG. 1. The one or more networks may include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The service platform 102 is configured to provide one or more services, which may be accessed by the user 108, through authentication of the user 108. One example service platform 102 includes a virtual merchant, whereby the user 108 is enabled (following authentication, etc.) to use retail services for purchasing products (e.g., goods, services, etc.) from the merchant, through a virtual location, such as, for example, a website, etc. The goods offered by the virtual merchant may include any physical item to be purchased, through the virtual location, and provided to the user 108, while the service(s) may include instructions, entertainment, connectivity, telecommunications, other services (e.g., streaming services, etc.), etc., which is purchased (e.g., at one time, or through a subscription, etc.) and delivered to the user 108 virtually (e.g., at the mobile device 106, etc.). In example embodiments, the service platform 102 may include any online website or mobile application, which a user can access for the purposes of e-commerce, social networking, online services (e.g., banking, retail, insurance, etc.), etc. In one example embodiment, such a service platform 102 may include, without limitation, AMAZON® online retailer and technology provider, etc.

That said, the service platform 102 should not be understood to be limited to being virtual merchants, as some merchants may have virtual and physical presences. What's more, the service platform 102 is not limited to any particular type of product to be purchased or provided with or without charge to the user 108. In yet another example, the service platform 102 is an account issuer, such as a credit card issuer, which offers a virtual location to access and/or management account data, etc.

More generally, the service platform 102 is configured to interact with the user 108 based on authentication of the user 108 through fast identity online (FIDO) authentication.

In connection therewith, the system 100 includes two FIDO servers 104a-b (e.g., multiple FIDO servers, etc.), but the system embodiment should not be understood to be limited to two FIDO servers, as additional FIDO servers may be employed in other embodiments. Also, as illustrated in FIG. 1, the FIDO servers 104a-b are illustrated as being separate from the service platform 102. In this way, the FIDO servers 104a-b may to integrated in whole, or in part, in another entity, partner, business, etc., such as, for example, the MASTERCARD® processing network, etc. In still other embodiments, the FIDO servers 104a-b may be integrated in whole, or in part, with the service platform 102.

Also, the FIDO servers 104a-b are associated with a software development kit (SDK) 110, which is configured to enable communication between the mobile device 106 and the FIDO servers 104a-b. In this example embodiment, the SDK 110 is included in a website or other virtual location of the service platform 102, and is executed by the service platform 102 and/or browser of the mobile device 106 (e.g., GOOGLE CHROME, MICROSOFT EDGE, etc.), as described below. It should be understood that the mobile device 106, then, may include any suitable device, such as, for example, a smartphone, laptop, tablet, etc., whereby the device is a computing device (e.g., consistent with computing device 200, etc.) that is mobile with the user 108. That said, in one or more embodiments, the mobile device 106 may be replaced with an immobile device, such as a desktop computer, server, etc., whereby the description herein is not limited to the mobile device 106 being mobile.

In addition, the SDK 110 includes executable instructions and information required to communicate with the FIDO servers 104a-b. Such instructions and information may include, for example, a uniform resource locator (URL) of the FIDO server 104a and, separately, the URL for the FIDO server 104b, etc. The instructions and information may also include identifying information for other FIDO servers, and also a description of services and/or other service platforms associated with the FIDO servers 104a-b and other FIDO servers.

In this example embodiment, the user 108 interacts with the service platform 102 (e.g., via the mobile device 106, etc.) to enroll for an account, initially, or to enroll for passwordless access, etc., through the website associated with the service platform 102, for example.

In doing so, the mobile device 106, as configured by the SDK 110, initiates enrollment of the user 108 with the FIDO server 104a. As part thereof, the mobile device 106 is configured to initiate an authentication of the user 108. That is, the mobile device 106 is configured to authenticate the user 104, via a biometric, a PIN or otherwise. The mobile device 106, in this example, is accessible to the user 104 based on authentication. For example, where the mobile device 106 is a smartphone, the smartphone may require a biometric of the user 108 to be presented, or a PIN to be entered, which the smartphone verifies to permit access. In this embodiment, the mobile device 106 is configured to authenticate the user 104 in a similar manner, and then, based on successful authentication, to generate a key pair. The key pair includes a private key and a public key. The mobile device 106 is configured, by the SDK 110, to store the private key in a secure location in the mobile device 106 (e.g., a trusted platform module (TPM), a trusted execution element (TEE), a secure element (SE), etc.). In this manner, the private key is unique or specific or private to the mobile device 106 (and thus, unknown apart from the mobile device 106).

The mobile device 106 is configured, by the SDK 110, to provide the public key and a credential ID, along with an email address of the user 104, a phone number associated with the user 104 and/or the mobile device 106, an ESN of the mobile device 106, etc., to the FIDO server 104a. The FIDO server 104a, in turn, is configured to store the same in a data structure as part of a user profile for the user 108.

The FIDO server 104a is configured to provide a challenge back to the mobile device 106. In response, the mobile device 106 is configured, by the SDK 110, to initiate authentication of the user 108, as above. When the authentication is successful, the mobile device 106 is configured, by the SDK 110, to access the private key and to sign the challenge and to transmit the signed challenge, along with a phone number, credential ID, ESN, etc., back to the FIDO server 104a. Upon receipt of the signed challenge, the FIDO server 104a is configured to retrieve the user profile for the user 108, and specifically, the public key, based on the additional information, and to verify the signature with the public key. In response to verification of the same, the FIDO server 104a is configured to confirm enrollment of the user 108 for passkey authentication for the service platform 102.

It should be appreciated, at least initially, that the passkey authentication is limited to the specific service platform 102 and the FIDO server 104a.

It should be further appreciated that, in connection with the description above, the challenge may be issued prior to generating the key pair in other embodiments, whereby the public key is returned with the signed challenge to be verified before creating the user profile.

As part of the above, or subsequently, the mobile device 106 is configured, by the SDK 110, to offer the option, to the user 108, to synchronize the public key with one or more other FIDO servers, such as, for example, the FIDO server 104b. The synchronize option, in general, will identify the FIDO servers 104a-b to be synchronized, by name, service, availability, etc., in order to, for example, extend availability of the services from the FIDO server 104a, for authentication, or potentially, to extend the authentication to additional services, as suited to the particular service platform 102, etc. (e.g., to the FIDO server 104b, etc.). The FIDO servers 104a-b to be synchronized will be identified in a manner that permits the user 108 to provide informed consent as to the specific sharing of the public key. For example, the service platform 102, through the SDK 110, may include a list of available services (e.g., linked to particular FIDO servers, etc.) and/or available FIDO servers, whereby the list may be presented to the user 108, at the mobile device 106, for identification, selection, and/or consent to extend the passkey authentication.

When the user 108 selects to accept the synchronize option, the mobile device 106 is configured, by the SDK 110, to initiate authentication of the user 108, as explained above, based on a biometric or PIN from the user 108. Once authenticated, the mobile device 106 is configured, by the SDK 110, to retrieve the private key from the secure location, to generate a consent token, to sign the consent token with the private key, and to transmit the signed consent token, along with a phone number, email address, credential ID, ESN, etc., to the FIDO server 104b, i.e., the FIDO server to be synchronized (e.g., via path A in FIG. 1, etc.). In addition, the mobile device 106 is configured, by the SDK 110, to transmit a synchronize URL of the FIDO server 104a, i.e., the FIDO server having the public key, with the signed consent token. In various examples, the URL of the FIDO server 104a is known to (or is available to) the mobile device 106 based on the SDK 110 and enrollment of the user 108 with the particular FIDO server 104a.

In response, the FIDO server 104b is configured to identify the URL and to transmit the signed consent token, along with a phone number, email address, credential ID, ESN, etc., to the FIDO server 104a, through the URL (e.g., via path B in FIG. 1, etc.).

The FIDO server 104a is configured to then retrieve the user profile for the user 108 based on the phone number, email address, credential ID, ESN, etc. (received from the FIDO server 104b), and to verify the signed consent token with the public key from the user profile. When verified, the FIDO server 104a is configured to generate a response token, which includes the public key of the user 108, and then to sign the response token with a private key of the FIDO server 104a. The FIDO server 104a is configured to transmit the signed response token back to the FIDO server 104b (e.g., via path B in FIG. 1, etc.).

The FIDO server 104b is configured to verify the signature on the response token with a public key of the FIDO server 104a (as previously shared), to extract the public key from the response token, and to store the public key, along with the phone number, email address, credential ID, ESN, etc., in a data structure as part of a user profile for the user 108. Finally, the FIDO server 104b is configured to respond to the signed consent token, which includes a confirmation that the synchronization of the public key is complete and successful. In response, the service platform 102 is configured, via the SDK 110, to note the additional availability of the FIDO server 104b (e.g., based on an identifier, a URL, etc.). For example, the service platform 102 may update a list of available services and/or available FIDO servers for passkey authentication of the user 108.

In connection with a subsequent requirement for service(s) from the service platform 102, the service platform 102 is configured to seek passkey authentication of the user 108. To do so, the service platform 102 is configured to reach out to the FIDO server 104a to perform passkey authentication of the user 108.

In the absence of a response, the service platform 102 is configured to determine the FIDO server 104a to be unavailable (e.g., due to a timeout, etc.), and the service platform 102 is configured to then identify the FIDO server 104b as an alternate and to instruct the FIDO server 104b to authenticate the user 108. The FIDO server 104b is contacted via a URL thereof known to the service platform 102. In response, the FIDO server 104b is configured to provide a challenge back to the mobile device 106. The mobile device 106, in turn, is configured, by the SDK 110, to initiate authentication of the user 108 (e.g., biometric authentication, etc.), as above. When the authentication is successful, the mobile device 106 is configured, by the SDK 110, to access the private key, to sign the challenge, and to transmit the signed challenge, along with a phone number, credential ID, ESN, etc., back to the FIDO server 104a.

Upon receipt of the signed challenge, the FIDO server 104b is configured to retrieve the user profile for the user 108, and specifically, the public key, based on the additional information, and to verify the signature with the public key. In response to the verification being successful, the FIDO server 104b is configured to confirm the passkey authentication of the user 108 to the service platform 102. The service platform 102, in turns, is then configured to permit the user 108 access to one or more services associated therewith.

While the public key is shared with only one other FIDO server 104b in the above, it should be appreciated that additional FIDO server may be included as duplicates of the FIDO server 104b to synchronize the public key across the additional FIDO servers.

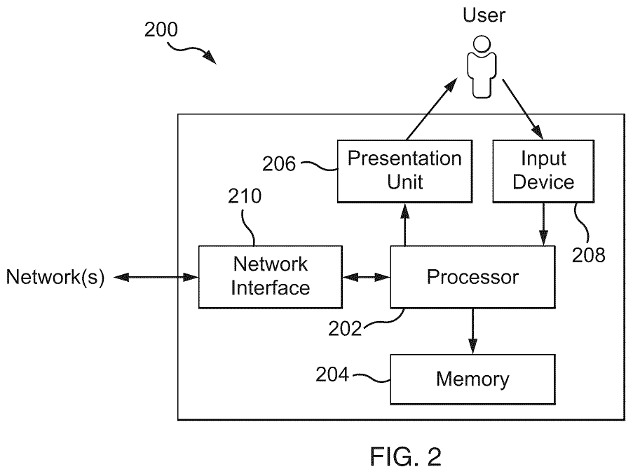

FIG. 2 illustrates an example computing device 200 that may be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to operate as described herein. In the example embodiment of FIG. 1, each of service platform 102, the FIDO servers 104a-b, and the mobile device 106 are understood to be included in, or as being generally implemented in, at least one computing device generally consistent with computing device 200, coupled to (and in communication with) the one or more networks. However, with that said, the system 100 should not be considered to be limited to the computing device 200, as described below, as different computing devices and/or arrangements of computing devices may be used.

Referring to FIG. 2, the example computing device 200 includes a processor 202 and a memory 204 coupled to (and in communication with) the processor 202. The processor 202 (as well as the processor 128) may include one or more processing units (e.g., in a multi-core configuration, etc.). For example, the processor 202 (as well as the processor 128) may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, floppy disks, tapes, hard disks, and/or any other type of volatile or nonvolatile physical or tangible computer-readable media. The memory 204 may be configured to store, without limitation, public keys, private keys, user profiles, tokens, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein, whereby such performance improves operation of the computing device (as described herein) and transforms the computing device 200 into a special-purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, such as listings of FIDO servers to be synchronized, prompts for user input, etc., audibly or visually, for example, to a user of the computing device 200, such as the user 108 in the system 100, etc. The presentation unit 206 may include, without limitation a liquid crystal display (LCD), a light-emitting diode (LED) or LED display, an organic LED (OLED) display, an “electronic ink” display, speakers, etc. In some embodiments, presentation unit 206 may include multiple devices.

In addition, the computing device 200 includes an input device 208 that receives inputs from the user of the computing device 200 (i.e., user inputs) such as, for example, selections of synchronization options, etc., as further described herein. The input device 208 may include a single input device or multiple input devices. The input device 208 is coupled to (and is in communication with) the processor 202 and may include, for example, a keyboard, a pointing device, a mouse, a sensor, a touch sensitive panel (e.g., a touch pad or a touch screen, etc.), another computing device, and/or an audio input device, etc. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., Wi-Fi adapter, a near field communication (NFC) adapter, a Bluetooth adapter, etc.), a mobile network adapter, or other device capable of communicating to one or more different networks, including the network 108. Further, in some example embodiments, the computing device 200 may include the processor 202 and one or more network interfaces incorporated into or with the processor 202.

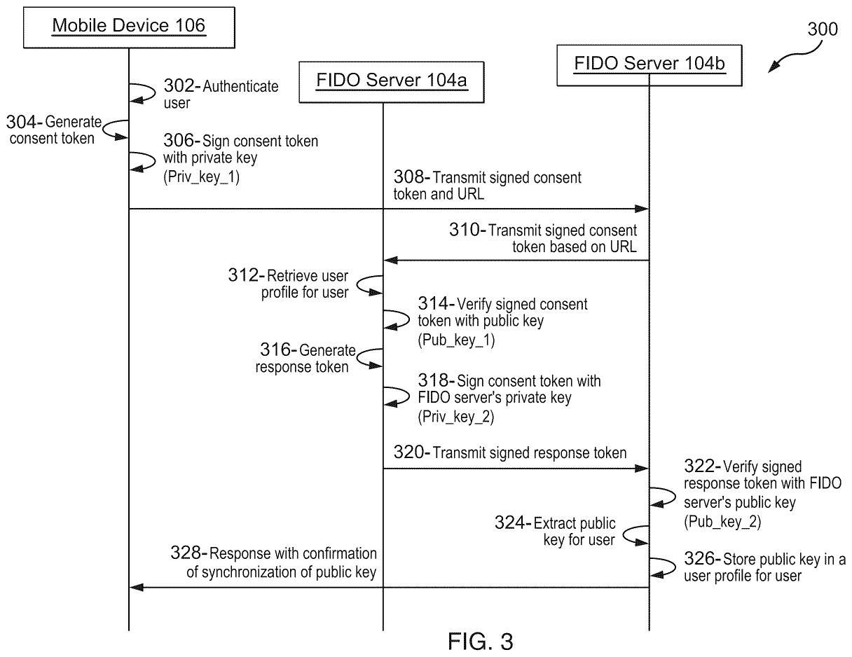

FIG. 3 illustrates an example method 300 for use in consent-based synchronizing keys for enhanced authentication availability for network services. The example method 300 is described as implemented in the FIDO servers 104a-b and other aspects of the system 100. And, reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, it should be appreciated that the user 108 is associated with one or more accounts with the service platform 102.

In connection therewith, the user 108 is enrolled for passkey authentication with the FIDO server 104a, for convenience of access to the account(s) at the service platform 102. Also, the service platform 102 includes (and/or is associated with) the FIDO server 104b to ensure availability of the passkey authentication (e.g., if the FIDO server 104a is not available, etc.). As such, in lieu of requesting the user 108 to enroll for passkey authentication with the FIDO server 104b, the service platform 102 offers the option to the user 108 (via the mobile device 106) to synchronize the public key (stored at the FIDO server 104a) for passkey authentication to the FIDO server 104b (e.g., to enable the user 108 to have redundant FIDO servers, to extend the passkey authentication to other services associated with the service platform 102, or otherwise, etc.). The option may be viewed at the mobile device 106, upon accessing the account of the user 108 with the service platform 102, or otherwise. The option generally includes a listing of the available FIDO servers 104a-b to be synchronized and/or a description of the services to which the authentication is to be applied, etc. (e.g., via an interface displayed at the mobile device showing available FIDO server options from which the user may select, etc.). It should be appreciated that the available FIDO server options may instead (or may additionally) be presented as additional services, from which the user 108 may select for passkey authentication.

In order to view the option, or to select the option, the mobile device 106 initiates an authentication of the user 108, at 302, whereby the mobile device 106 captures a biometric, or a PIN, from the user 108 and compares the same with a reference value stored in the mobile device 108. Upon successful authentication, and selection of the option to synchronize the public key with the FIDO server 104b, in this example, the mobile device 106 generates, at 304, a consent token, which may include details of the consent (e.g., date, time, MAC address, session details, authentication type, etc.), the option to synchronize, the phone number or ESN of the mobile device 106, etc., or other suitable information to document the consent of the user 108, etc. Depending on, for example, the content, the consent token may be encrypted based on a suitable encryption technique, or not.

At 306, the mobile device 106 signs the consent token with a private key of the mobile device 106, as stored in a secure location thereof, i.e., Priv_key_1. At 308, the mobile device 106 transmits the signed consent token and a synchronize URL of the FIDO server 104a, i.e., the FIDO server having the public key, to the FIDO server 104b. In various examples, the URL of the FIDO server 104a is known to (or is available to) the mobile device 106 based on the SDK 110, and further identified as available based on enrollment of the user 108 with the FIDO server 104a. It should be appreciated that the URL of the FIDO server 104a may be set as a default until the passkey authentication is extended to other FIDO servers, whereupon the user 108 may be provided a list of options from which to select (as described herein). The mobile device 106 may include additional information, such as, for example, the phone number of the mobile device 106, an email address, ESN of the mobile device 106, credential ID, etc., which is associated with the user 108, the mobile device 106, or the prior enrollment with the FIDO server 104a.

At 310, the FIDO server 104b transmits the signed consent token, along with a phone number, email address, credential ID, ESN, etc., to the FIDO server 104a, through the URL. The message including the signed consent token and the URL may again be encrypted based on a suitable encryption techniques (e.g., Transport Layer Security (TLS) protocol, etc.), or not.

The FIDO server 104a retrieves, at 312, the user profile for the user 108 based on the phone number, email address, credential ID, ESN, etc., and verifies, at 314, the signed consent token with the public key from the user profile, i.e., Pub_key_1.

Based on the consent token being verified, at 316, the FIDO server 104a generates a response token, which includes the public key of the user 108. It should be appreciated that the response token may include additional information, as desired. The FIDO server 104b, at 318, signs the response token with a private key of the FIDO server 104a, i.e., Priv_key_2.

At 320, the FIDO server 104a transmits the signed response token back to the FIDO server 104b. The message including the signed consent token and the URL may again be encrypted based on a suitable encryption technique (e.g., TLS protocol, etc.), or not.

The FIDO server 104b verifies, at 322, the signature on the response token with a public key of the FIDO server 104a (as previously shared), i.e., Pub_key_2. The FIDO server 104b extracts, at 324, the public key from the response token and stores, at 326, the public key, along with the phone number, email address, credential ID, ESN, etc., in a user profile for the user 108. Finally, the FIDO server 104b responds to the mobile device 106, at 328, to the signed consent token, which includes a confirmation that the synchronization of the public key at the FIDO server 104b, as selected, is complete and successful. The service platform 102 (e.g., via the SDK 110 at the mobile device 106, etc.) then identifies the URL for the FIDO server 104b as an available FIDO server, in addition (or as an alternative to) the FIDO server 104a.

As such, in connection with subsequent passkey authentication, the mobile device 106, and in particular the service platform 102, may permit the user 108 to selected between the FIDO server 104a and the FIDO server 104b from a list of available FIDO servers/services, or simply, use the FIDO server 104a as the default and the FIDO server 104b as a backup (e.g., depending on the services provided by the service platform 102 and/or selected by the user 108, etc.).

In connection therewith, when selected, or when the FIDO server 104a is determined to be unavailable (e.g., due to a timeout, etc.), the service platform 102 instructs the FIDO server 104b to authenticate the user 108. The FIDO server 104b is instructed, by the service platform 102, based on the URL of the FIDO server 104b, as known by the service platform 102 and included in the user profile. In response, the FIDO server 104b provides a challenge to the mobile device 106. The mobile device 106, in turn, initiates authentication of the user 108 (e.g., via biometric authentication at the mobile device 106, or PIN authentication, or otherwise, etc.).

When the authentication is successful, the mobile device 106 accesses the private key therein and signs the challenge. The mobile device 106 then transmits the signed challenge, along with a phone number, credential ID, ESN, etc., back to the FIDO server 104b. Upon receipt of the signed challenge, the FIDO server 104b retrieves the user profile for the user 108, and specifically, the public key, based on the additional information. The FIDO server 104b then verifies the signature using the public key. In response to the signature being verified, the FIDO server 104b then confirms passkey authentication of the user 108 to the service platform 102, whereby the service platform 102 the permits the user 108 to access services provided thereby.

Again, while the public key is shared with only one other FIDO server 104b in the method 300, it should be appreciated that the steps therein may be repeated for one or more additional FIDO serves as consent by the user 108.

In view of the above, the systems and methods herein permit consent-based synchronizing of keys for enhanced authentication availability for network services. By sharing a public key from a FIDO server, with which the user is enrolled, to one or more other FIDO servers, access to the authentication based on the public key is not limited to only the FIDO server with which enrollment was completed but extended to the other FIDO servers. As such, where the original FIDO server is unavailable or not selected as a primary FIDO server, for some reason, the user may still be authenticated through use of the one or more other FIDO servers, and public key shared therewith, yet without the user separately being required to enroll with each of the one or more other FIDO servers. The authentication is extended, therefore, through a technical solution, to provide resiliency and highly available passkey authentication, and the services protected by the passkey authentication.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing: (a) receiving, by a first fast identity online (FIDO) server, from a second FIDO server, a signed consent token, which is signed by a first private key specific to a mobile device of a user; (b) retrieving, by the first FIDO server, a user profile for a user; (c) verifying, by the first FIDO server, the signed consent token based on a first public key included in the user profile; (d) based on the successful verification of the consent token, generating, by the first FIDO server, a response token, which includes the first public key; (e) signing, by the first FIDO server, the response token with a second private key unique to the first FIDO server; and/or (f) transmitting the signed response token to the second FIDO server, whereby the second FIDO server verifies the signed response token based on a second public key and extracts the first public key from the response token to permit the second FIDO server is authentication the user at the mobile device based on the first public key, when the first FIDO server is unavailable.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in consent-based synchronizing of keys for enhanced authentication availability for network services, the method comprising:
receiving, by a first fast identity online (FIDO) server, from a second FIDO server, a signed consent token, which is signed by a first private key specific to a mobile device of a user;
retrieving, by the first FIDO server, a user profile for a user;
verifying, by the first FIDO server, the signed consent token based on a first public key included in the user profile;
based on the successful verification of the consent token, generating, by the first FIDO server, a response token, which includes the first public key;
signing, by the first FIDO server, the response token with a second private key, which is unique to the first FIDO server; and
transmitting the signed response token to the second FIDO server, whereby the second FIDO server verifies the signed response token based on a second public key and extracts the first public key from the response token to permit the second FIDO server to authenticate the user at the mobile device based on the first public key, when the first FIDO server is unavailable.

2. The computer-implemented method of claim 1, wherein the first public key is specific to a service platform; and
further comprising identifying, by the service platform, the second FIDO server, based on a uniform resource locator (URL) of the second FIDO server, as available for authenticating the user.

3. The computer-implemented method of claim 1, further comprising enrolling the mobile device for passkey authentication based on the first public key and the first private key.

4. The computer-implemented method of claim 1, wherein receiving the signed consent token includes further receiving at least one of: a phone number specific to the mobile device, a device identifier of the mobile device, and/or a credential ID; and
wherein retrieving the user profile includes retrieving the user profile based on the at least one of: a phone number specific to the mobile device, a device identifier of the mobile device, and/or a credential ID.

5. The computer-implemented method of claim 1, wherein the response token further includes at least one of: a phone number specific to the mobile device, a device identifier of the mobile device, an email address specific to the user, and/or a credential ID.

6. The computer-implemented method of claim 1, wherein receiving the signed consent token from the second FIDO server is based on a consent of the user, at the mobile device, to share the first public key with the second FIDO server.

7. The computer-implemented method of claim 1, further comprising:
receiving, by the second FIDO server, the signed response token;
verifying, by the second FIDO server, the signed response token based on the second public token;
extracting, by the second FIDO server, the first public key from the response token; and
storing, by the second FIDO server, in a memory, the first public key in the user profile for the user to permit the second FIDO server to authenticate the user at the mobile device based on the first public key, when the first FIDO server is unavailable.

8. The computer-implemented method of claim 7, wherein the second public key is unique to the first FIDO server; and
further comprising authenticating, by the second FIDO server, the user based on the first public key in connection with a message, which is signed by the first private key.

9. A system for use in consent-based synchronization of keys for enhanced authentication availability, the system comprising:
a first fast identity online (FIDO) server, which is configured, by executable instructions, to:
receive, from a second FIDO server, a signed consent token, which is signed by a first private key specific to a mobile device of a user;
retrieve a user profile for a user;
verify the signed consent token based on a first public key included in the user profile;
based on the successful verification of the consent token, generate a response token, which includes the first public key;
sign the response token with a second private key unique to the first FIDO server; and
transmit the signed response token to the second FIDO server, whereby the second FIDO server verifies the signed response token based on a second public key and extracts the first public key from the response token to permit the second FIDO server to authenticate the user at the mobile device based on the first public key, when the first FIDO server is unavailable.

10. The system of claim 9, wherein the first public key is specific to a service platform.

11. The system of claim 9, wherein the first FIDO server is further configured, by executable instructions, to enroll the mobile device for passkey authentication based on the first public key and the first private key.

12. The system of claim 9, wherein the first FIDO server is further configured, by executable instructions, to receive at least one of: a phone number specific to the mobile device, a device identifier of the mobile device, and/or a credential ID; and
wherein the first FIDO server is configured to retrieve the user profile based on the at least one of: a phone number specific to the mobile device, a device identifier of the mobile device, and/or a credential ID.

13. The system of claim 9, wherein the response token further includes at least one of:
a phone number specific to the mobile device, a device identifier of the mobile device, an email address specific to the user, and/or a credential ID.

14. The system of claim 9, wherein the first FIDO server is configured to receive the signed consent token from the second FIDO server based on a consent of the user, at the mobile device, to share the first public key with the second FIDO server.

15. The system of claim 9, further comprising the second FIDO server, which is configured, by second executable instructions, to:
receive the signed response token;
verify the signed response token based on the second public token, which is unique to the first FIDO server;
extract the first public key from the response token; and
store, in a memory, the first public key in the user profile for the user to permit the second FIDO server to authenticate the user at the mobile device based on the first public key.

16. The system of claim 15, wherein the first public key is specific to a service platform; and
wherein the service platform is configured to identify the second FIDO server, based on a uniform resource locator (URL) of the second FIDO server, as available for authenticating the user.

17. The system of claim 16, wherein the service platform is configured to instruct the second FIDO server to authenticate the user, based on the URL of the second FIDO server; and
wherein the second FIDO server is further configured, by the second executable instructions, to authenticate the user at the mobile device, based on the first public key and a signed challenge from the mobile device.

18. The system of claim 16, wherein the service platform is configured to instruct the second FIDO server to authenticate the user, based on the URL of the second FIDO server, after determining that the first FIDO server is unavailable.

19. A non-transitory computer-readable storage medium comprising executable instructions for use in consent-based synchronizing keys for enhanced authentication availability for services, which when executed by at least one processor, cause the at least one processor to:
receive, from a second FIDO server, a signed consent token, which is signed by a first private key specific to a mobile device of a user;
retrieve a user profile for a user;
verify the signed consent token based on a first public key included in the user profile;
based on the successful verification of the consent token, generate a response token, which includes the first public key;
sign the response token with a second private key unique to the first FIDO server; and
transmit the signed response token to the second FIDO server, whereby the second FIDO server verifies the signed response token based on a second public key and extracts the first public key from the response token to permit the second FIDO server to authenticate the user at the mobile device based on the first public key, when the first FIDO server is unavailable.
